(19) United States
(12) Patent Application Publication
(10) Pub. No.: US 2024/0385037 A1
(43) Pub. Date: Nov. 21, 2024

(54) Spectrophotometer comprising phononic MEMS structure for sensing absorptive fluid

(71) Applicant: William N. Carr, Gainesville, FL (US)

(72) Inventor: William N. Carr, Gainesville, FL (US)

(21) Appl. No.: 18/654,968

(22) Filed: May 3, 2024

(51) Int. Cl. G01J 3/02; G01J 3/28

(52) U.S. Cl. CPC G01J 3/0259; G01J 3/0202; G01J 3/0286; G01J 3/2803

(57) ABSTRACT

A phononic MEMS spectrophotometer (PMS) comprising a photonic source and a photonic detector wherein a photonic beam from the photonic source is directed through a fluid of interest and terminated into a photonic detector. The fluid may be a gas or a liquid. A preferred embodiment comprising phononic MEMS structure is nanowires formed with phononic crystal structure. Phononic nanowire support structure provides increased thermal isolation in pixels comprising thermal micro-platforms. In embodiments, a micro-platform is thermally isolated to an extent that it cools itself through spontaneous blackbody radiation at room temperature.

### FIELD OF THE INVENTION

This invention relates generally to a spectrophotometer comprising a photonic source and a semiconductor detector.

### BACKGROUND OF THE INVENTION

The field of MEMS devices includes applications across a broad range of technologies including semiconductor integrated circuits including applications based on 3-dimensional structuring. The first semiconductor MEMS device was disclosed by H. Nathanson and R. Wickstrom in U.S. Pat. No. 3,413,573 issued 1968 as a resonant cantilever semiconductor device, wherein an actuated cantilever modulates the transconductance of a MOSFET transistor within an accelerometer device.

More recent cantilevered semiconductor MEMS devices include a thermally-actuated single-ended SPST switch with both in-plane (lateral) and out of plane (vertical) actuation disclosed by W. Carr and X-Q Sun in U.S. Pat. No. 5,796,152 issued 1998. A cantilever comprising a thermal MEMS structure with multiple cantilevers providing a capacitive readout is disclosed in G. Fedder and A. Oz, U.S. Pat. No. 7,749,792 issued in 2010.

None of the above mentioned MEMS devices comprise phononic microelectromechanical structure (MEMS). In the present invention, semiconductor devices are disclosed based on phononic MEMS structure. The phononic MEMS structure decreases the thermal conductivity of internal supporting nanowires and increases thermal isolation for a suspended micro-platform.

Phononic MEMS structure within a semiconductor apparatus is first disclosed by W. Carr in U.S. Pat. No. 9,006,857 issued Apr. 14, 2015. A recent patent comprising a photonic crystal (PtC) waveguide-based sensor for identifying an exposed molecular species is disclosed by W. Carr in U.S. Pat. No. 11,231,382 issued Jan. 28, 2022.

Semiconductor phononic structure is also disclosed by Carr for MEMS photonic devices including U.S. Pat. No. 11,300,453, issued Apr. 12, 2022, U.S. Pat. No. 11,309,473 issued Apr. 19, 2022, U.S. Pat. No. 11,381,761 issued Jul. 5, 2022 and U.S. Pat. No. 11,961,988 issued Apr. 16, 2024.

FIG. 1 is a graph of thermal conductivity listed for a plurality of reported silicon nanowires, each configured with a phononic crystal PnC, wherein thermal conductivity is reduced. In FIG. 1 thermal conductivity of the nanowire is plotted as a function of the neck dimension n within the nanowire as the PnC thermal conductivity over recent years has consistently decreased. FIG. 1 is disclosed by M. Nomura et al, Review of thermal transport in phononic crystals”, Materials Today Physics, vol. 22, '00613 (2022). The most recent thermal conductivity for phononic nanowires is reported with a minimum of near 1 watt/mK. This low value of thermal conductivity approaches the level normally associated with a dielectric and is more than two-orders of magnitude reduced from bulk silicon crystal level.

Responsivity R of the photonic detector in the present application is enhanced by the phononic MEMS structure in the supporting. With phononic MEMS nanowire structure the desired signal to noise ratio for detector operation is increased.

In embodiments of the present invention, a metamaterial resonant absorber with a sharp resonance is disposed in a photonic thermal emitter to increase emissivity at a controlled wavelength and within a limited bandwidth range. In embodiments of the present invention, the same metamaterial with a sharp resonance disposed in a thermal detector increases the detectivity at a controlled wavelength and within a limited bandwidth. Based on the Kirchhoff law of thermal radiation, at thermal equilibrium the emissivity of a material equals its absorptivity. An example of an infrared emitter design without phononic structure is based on the Kirchhoff law of thermal radiation is the photonic emitter disclosed in X. Liu et al, Phys. Rev. Letters, vol. 107, 0459 (2011).

In the present invention, devices comprising phononic MEMS structure are disclosed for a spectrophotometer application wherein a photonic beam passes through an absorbent fluid of interest with termination into a photonic detector.

### SUMMARY OF THE INVENTION

This patent application discloses a phononic MEMS spectrophotometer (PMS) comprising a photonic source and a photonic detector wherein a photonic beam from the photonic source is directed through an absorptive or reflective fluid of interest into a photonic detector.

FIG. 2 depicts the spectrophotometer with its primary operational components which comprise a photonic source 202, photonic detector 203, and surrounding isothermal substrate(s) 201. The photonic beam 205 from the photonic source 202 is partially absorbed or deflected by component species within the fluid media of interest 204, and the photonic beam 206 continues on into the photonic detector 203.

The photonic source comprises one or more of a thermal light emitting platform (LEP), a light emitting diode (LED), and a laser, providing one more photonic beams with spectral components within the VIS-LWIR wavelength range. Each photonic beam is directed through the fluid of interest and on into the photonic detector. The fluid of interest comprises a gas or liquid.

In embodiments, the semiconductor LEP comprises a micro-platform suspended from phononic MEMS nanowires.

In all embodiments, the photonic detector comprises a sensor structure disposed on a micro-platform suspended by phononic MEMS nanowires from an isothermal surrounding substrate. The micro-platform is configured to provide increased absorptive sensitivity for spectral components from the photonic source within the VIS-LWIR wavelength range of radiation from the photonic source(s).

In embodiments, the photonic detector is configured as a thermal detector comprising a thermoelectric thermopile, a thermistor bolometer, pyroelectric sensor or a photodiode.

The phononic MEMS supporting nanowires comprise phononic crystal or random phononic scattering elements, thereby reducing the thermal conductivity of said nanowires and increasing thermal isolation of the suspended micro-platform. The phononic MEMS nanowires comprise one or more sections, each section comprising phononic crystal or other phononic structural elements.

The distance between phononic MEMS structural elements within the nanowires is less than the mean free path (mfp) of at least some heat conducting phonons. The phononic MEMS nanowires increase the ratio of electrical to thermal conductivity within each nanowire.

The micro-platform and nanowires are disposed within a hermetic cavity. This hermetic cavity is generally maintained at a vacuum level less than 5 milliTorr

The signal levels from the detector are processed with a signal analyzer and controller to provide a monitoring or identification of one or more components within the fluid of interest.

In embodiments, the photonic detector may be formed of one or more micro-platforms suspended with phononic MEMS nanowires from an isothermal surrounding substrate. The micro-platform of the photonic detectors is configured to provide sensitivity for radiation received from the photonic source within the VIS-LWIR wavelength range.

In embodiments, the photonic detector comprises one or more of a thermoelectric thermopile, resistive bolometer, pyroelectric sensor or photodiode. The thermopile, resistive bolometer and pyroelectric sensor are all formed with phononic MEMS supporting nanowires. In some embodiments, a photodiode may also be disposed on a micro-platform supported by the phononic MEMS nanowires.

The phononic MEMS nanowires may comprise one or more area-sections of phononic structure, each area-section comprising one or more layers of phononic crystal or randomly disposed phononic nanoscale scattering elements, thereby providing a decreased thermal conductivity along the length of the nanowires. In a preferred embodiment, the phononic MEMS structure in a nanowire is formed of phononic crystal (PnC).

The phononic MEMS nanowires comprise one or more layers of semiconductor, dielectric, or metallic film, providing one or more of, without limitation, an increase in mechanical strength, an increase in electrical conductivity, static positioning, or electrical isolation.

In embodiments, the photonic detector comprises one or more micro-platforms, wherein each micro-platform is suspended by phononic MEMS nanowires from the isothermal surrounding substrate. In embodiments wherein the photonic source is an LEP, the thermal platform is supported by phononic MEMS nanowires.

In embodiments, a plurality of the micro-platforms comprise photonic sources connected in a series/parallel circuit providing a load impedance matched to a selected source of electrical power or providing multiple wavelengths of radiation.

In embodiments, the detector micro-platform is sufficiently thermally isolated, wherein the micro-platform cools itself by itself own blackbody radiation.

In embodiments wherein the micro-platform is spontaneously self-cooled, a steady, internal signal level is created affected by the temperature of the micro-platform. In this embodiment, a synchronous detection circuit separates the photon beam source signal from the separate steady signal resulting from spontaneous cooling of the micro-platform.

In a preferred embodiment, the synchronous detection circuit is used in thermopile applications wherein the photonic source beam is chopped.

In another preferred embodiment the synchronous detection circuit is used for resistive bolometer applications wherein the interrogation current for the bolometer resistor is cycled on and off in successive data acquisition frames.

In embodiments, a mirror exposed to one surface of the micro-platform in a detector reflects light to the micro-platform, thereby increasing the net respective radiation efficiency or responsivity R of said micro-platform. In other embodiments, a mirror increases the efficiency for an LEP.

In embodiments, the micro-platform comprises resonant structure controlling the wavelength bandwidth of emissivity or absorptivity according to the Kirchhoff law of thermal radiation.

The micro-platform comprises, without limitation, carbon nanotubes, graphene, silicon black, carbon black, and gold black, providing an increase in emissivity or absorptivity for the photonic source or photonic detector, respectively, according to the Kirchhoff law of thermal radiation.

The phononic MEMS nanowires comprise one or more layers of crystalline or polycrystalline semiconductor material selected from the group comprise, without limitation, silicon, silicon germanium, germanium, silicon carbide, gallium nitride, vanadium oxide, and complex thermoelectric semiconductors.

In embodiments, the nanowires are comprised of silicon and oxidized in a heated environment after release to create the dielectric film on both sides of the nanowire, thereby increasing nanowire mechanical strength and decreasing thermal conductivity.

The one or more layers of a dielectric within the nanowires is selected from the group, without limitation, silicon dioxide, aluminum oxide, and silicon nitride.

The discrete structural elements within the phononic MEMS nanowire comprise, without limitation, holes, vias, pillars, surface dots, plugs, cavities, indentations, surface particulates, roughened edges, implanted molecular species, porous structure, and molecular aggregates, disposed in a periodic or random format.

The fluid of interest comprises one or more of, without limitation, an atmosphere comprising an exhaust or smokestack effluent, drinking water, breath, blood, urine, and a liquid or gaseous product from a chemical reaction.

In embodiments, the fluid of interest comprises one or more or more of chemical species, without limitation, O2, H2O, H2O2, CH4, BBr3, C2H6, C2H2, HBr, CO, CO2, NH3, NO, NO2, C2H5OH ethanol, and CH2O.

In embodiments, the fluid of interest comprises reflective particulates such as dust and sand.

In embodiments the spectrophotometer is configured as an oximeter sensitive to the hemoglobin oxygen content of blood.

In embodiments, the spectrophotometer configured to monitor the glucose content of blood.

In embodiments, the molecular species of interest comprises, without limitation, biomedical tissue or material from within a living body.

The micro-platforms are formed with a lateral dimension within the range 1 to 2000 micrometers, and the phononic nanowires are formed with a thickness within the range 10 to 500 nanometers.

### BRIEF DESCRIPTION OF THE DRAWINGS

FIG. 1 is a graph of nanowire thermal conductivity plotted versus a dimension of phononic crystal structure (prior art).

FIG. 2 is a block diagram of the photonic source, directed photonic beam, and photonic detector within the spectrophotometer.

FIGS. 3A-3D depicts plan views of the phononic MEMS nanowires.

FIGS. 4A, 4B, 4C depict cross sectional views of the phononic MEMS nanowires.

FIG. 5 depicts a cross-sectional view of a phononic MEMS nanowire with a dielectric film on both major surfaces of a micro-platform.

FIG. 6 depicts a plan view of the micro-platform supported by two nanowires.

FIG. 7 depicts a plan view of the micro-platform supported by four nanowires.

FIG. 8 is a graph of nanowire stress as a function of pixel acceleration with a specific vector direction.

FIG. 9 is a graph of blackbody radiated power as a function of surface temperature.

FIG. 10 is a cross sectional view depicting blackbody radiation from a micro-platform and an exposed structured cavity surface/

FIG. 11A, 11B depict a synchronous switch and waveforms for separating the steady pixel signal from the photonic beam signal.

FIGS. 12A-12D depicts thin film resonant metamaterial structures disposed on a portion of a micro-platform.

FIG. 13 depicts a detector pixel circuit with hyperspectral detectivity.

FIG. 14A is a cross-sectional view depicting a micro-platform with a nanotube absorber and with a wire-bonded interpixel connection.

FIG. 14B is a cross-sectional view depicting a micro-platform with a nanotube absorber and with a through-silicon-via (TSV) interpixel connection.

FIG. 15 is a cross-sectional view depicting a micro-platform with a nanotube absorber and diffused dielectric layers.

FIG. 16 is a plan view depicting an array of four interconnected phononic MEMS pixels.

FIG. 17 is a cross-sectional view depicting the spectrophotometer comprising two phononic MEMS pixels.

FIG. 18 is a plan view depicting the spectrophotometer comprising eight photon sources with photonic beams directed into a single detector.

FIG. 19A is a cross-sectional view depicting the spectrophotometer comprising a photonic source and a photonic detector with the photonic beam wherein the absorbing fluid is blood in a human finger.

FIG. 19B is a cross-sectional view depicting the spectrophotometer comprising a photonic source and a photonic detector wherein the absorbing fluid is human exhaled breath.

FIG. 20 depicts components for characterizing the photonic source power efficiency and the photonic detector NEP.

FIGS. 21A, 21B are cross-sectional views depicting a silicon micro-platform before and after growing an oxide layer in a heated atmosphere, respectively.

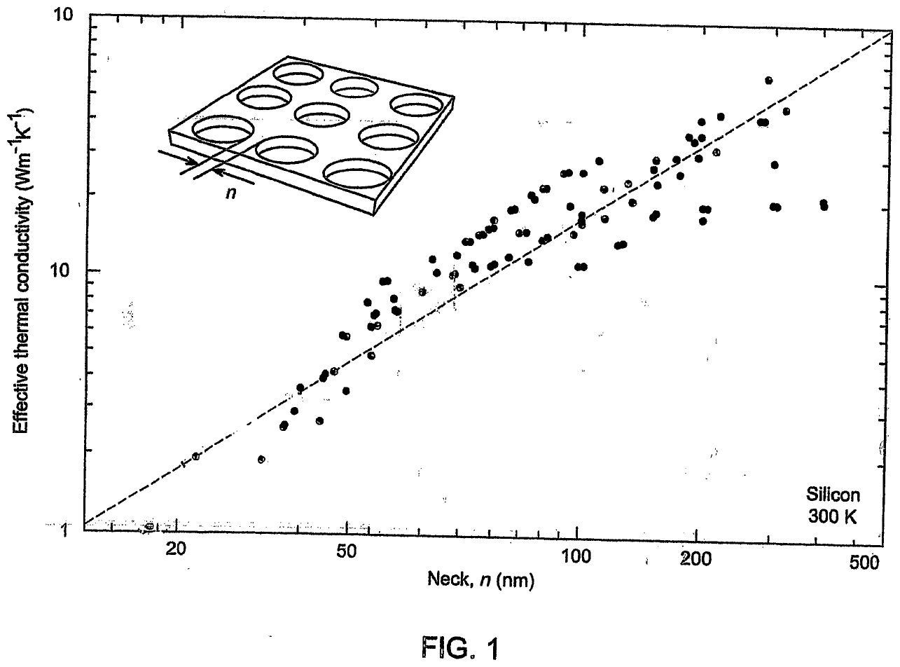

### DETAILED DESCRIPTION

Definitions: The following terms are explicitly defined for use in this disclosure and the appended claims:
“thermal micro-platform” means a micro-platform supported by phononic MEMS structured nanowires providing increased thermal isolation for the micro-platform. The micro-platform and its supporting nanowires comprise a pixel.
“LED” means a semiconductor device which radiates light within the spectral visible-infrared range when a pn junction is forward biased.
“LEP” means a semiconductor light emitting platform which radiates blackbody light with maximum intensity within the infrared spectral range.
“blackbody light” means radiation from a surface based on the Phelan-Boltzmann radiation equation where radiated intensity is proportional surface temperature temperature T⁴.
“Responsivity (R) means the ratio of the detector response signal amplitude divided by the absorbed photonic beam power.
“Kirchhoff's law of thermal radiation states that photonic emissivity of a surface equals its photonic absorptivity wherein the surface is in thermal equilibrium with its surroundings.
“VIS-LWIR” means a light beam with wavelength components within the visible to long-wavelength infrared range.
“comprising” means to include at least in part.

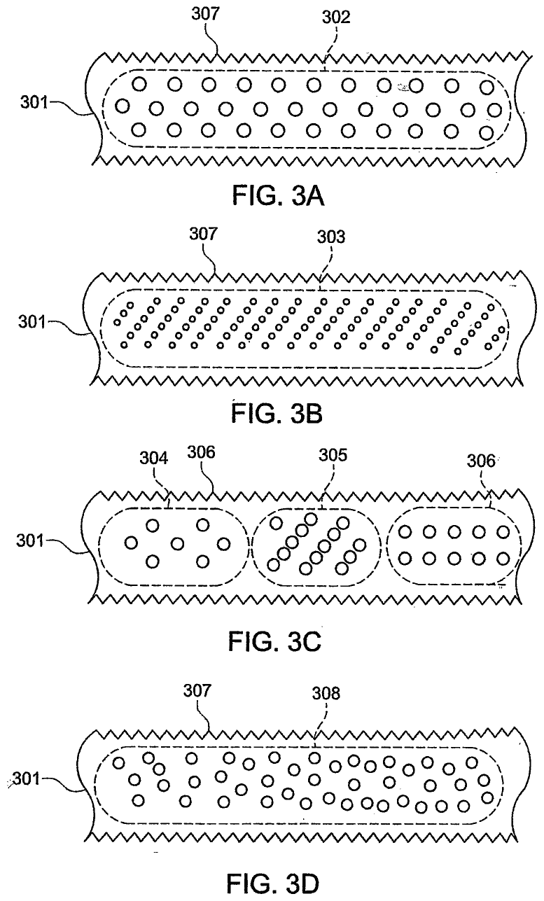

FIGS. 3A-3D depict plan views of the phononic MEMS nanowires. FIG. 3A is an example of a flat nanowire 301 with phononic crystal 302, 307 wherein nano-scaled elements are disposed in an orderly fashion. These nano-scaled elements are generally holes penetrating through the nanowire, but in imbodiments the nano-scaled elements can comprise any of a number of shapes including bumps and indendations in the nanowire bulk and surfaces.

FIG. 3B depicts the plan view of a phononic MEMS nanowire 301 with the nanoscale elements 303 arranged at an angle with respect to overall phononic thermal transport vector. This arrangement reduces thermal conductivity further. FIG. 3C depicts the nanowire 301 comprised of multiple nano-scaled-elements 304, 305, 306 of different phononic structure disposed along the length of a nanowire.

FIG. 3D depicts a plan view of a phononic nanowire 301 wherein nanoscale elements 307, 308 are disposed in a random manner.

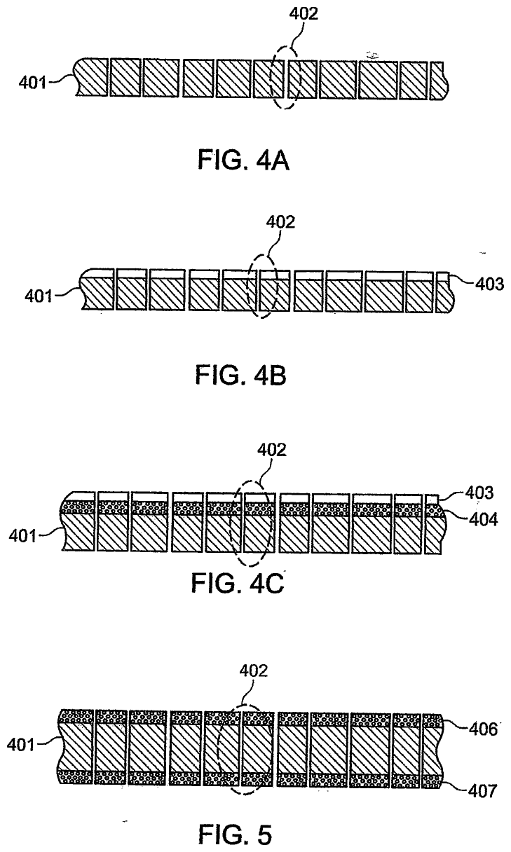

FIGS. 4A, 4B, 4C depict cross sectional views of a phononic MEMS nanowire. FIG. 4A is an example of the nanowire embodiments 401 of FIGS. 3A-3D comprising a single level of semiconductor. In a preferred embodiment, the semiconductor is silicon crystal.

FIG. 4B is an example of a nanowire 401 with a metal film 403 on one surface. FIG. 4C is an example of the nanowire 401 with both a metal 403 and a dielectric film 404 covering a surface of the nanowire 401.

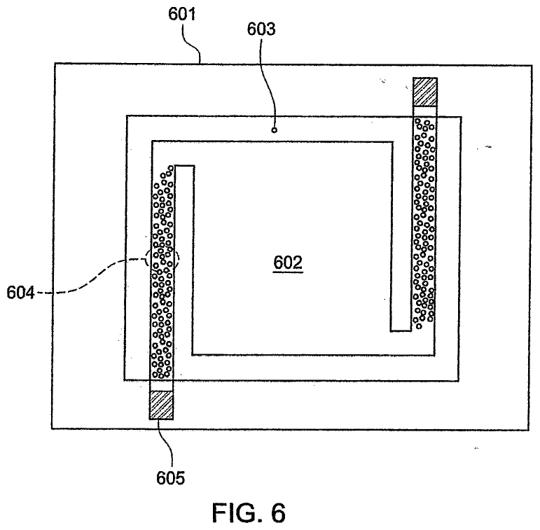

FIG. 5 depicts a cross-sectional view of a phononic MEMS nanowire 401 with a dielectric film 406, 407 on both major surfaces of a micro-platform. In embodiments, the dielectric film is desirable.

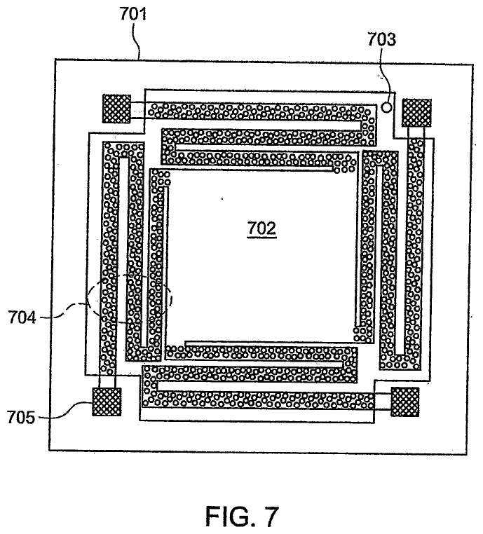

FIG. 6 depicts a plan view of a micro-platform 602 supported by two nanowires 604 wherein the nanowires are suspended from surrounding platform 601 at bonding pads 605. The nanowires are illustrated with randomly disposed micro-scaled scattering elements.

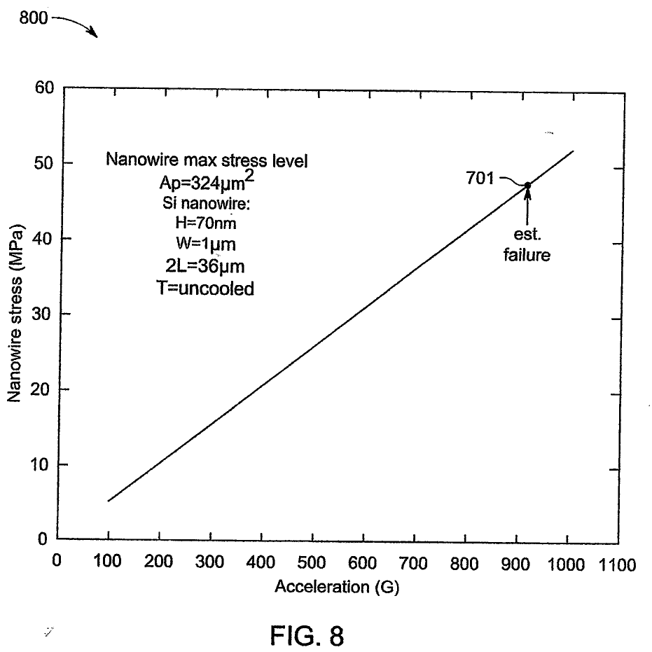

FIG. 7 depicts a plan view of a micro-platform 702 supported by four nanowires 704 suspended from surrounding platform 701 at bonding pads 705.

The nanowires are depicted in an extended form which, in embodiments, increases thermal isolation of the micro-platform.

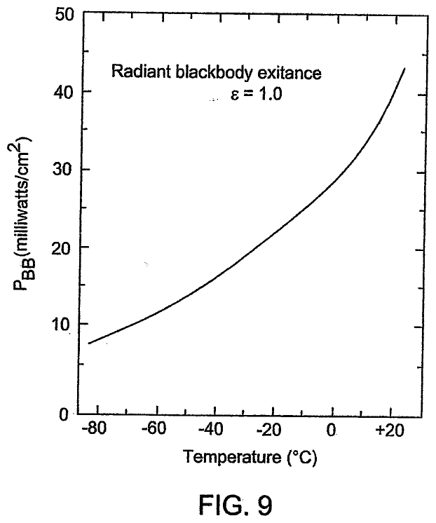

FIG. 8 is a graph of nanowire stress as a function of pixel shock acceleration with a specific vector direction simulated with COMSOL. The referenced pixel in this example is a crystalline silicon micro-platform of area Ap=324 um2 supported from two nanowires, each with length L=18 um. Acceleration at 900 G reaches the 47 MPa stress limit 701 for silicon.

### Spontaneous Cooling of the Thermally Isolated Micro-Platform

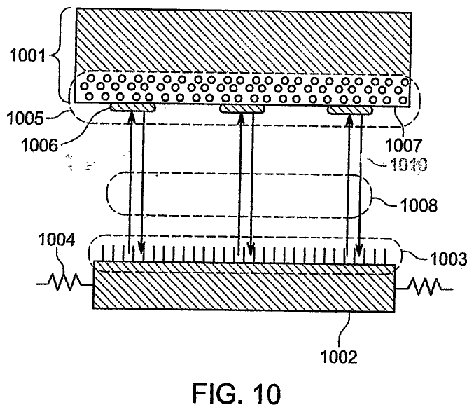

FIG. 9 is a graph of blackbody radiated power density PBB as a function of surface temperature T from a surface having high emissivity (ε=1). At 20 deg C. a surface of high emissivity radiates 42 mW/cm² over all wavelengths. Peak radiation intensity at room temperature is at 10 um wavelength. If all of this blackbody radiation cools the surface, and nominal heat is received from surroundings including the nanowires, the surface is cooled with up to 42 mW/cm². This cooling power can cool a micro-platform with micrometer dimensions multiple tens of degrees Centigrade.

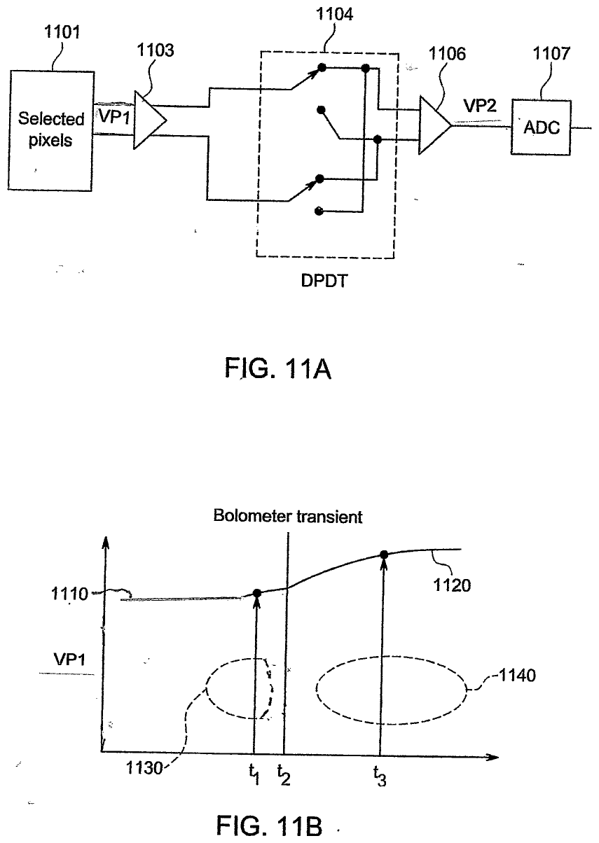

FIG. 10 is a cross sectional view depicting a phononic pixel section with iinternal spontaneous blackbody radiation components 1008 indicated from both the micro-platform 1002 and the surrounding hermetic cavity wall 1005.

Blackbody radiation 1008 from the micro-platform and the surrounding cavity wall cool and heat the micro-platform, respectively. This pixel view without the photonic beam is provided for illustrative purposes only.

In embodiments, the blackbody radiation from the exposed cavity surface is reduced by resonant highly absorptive metamaterial structure 1003 such as carbon nanotubes. The micro-platform is supported by nanowires 1004 within the hermetic cavity.

### Synchronous Circuit Configuration for Noise Reduction

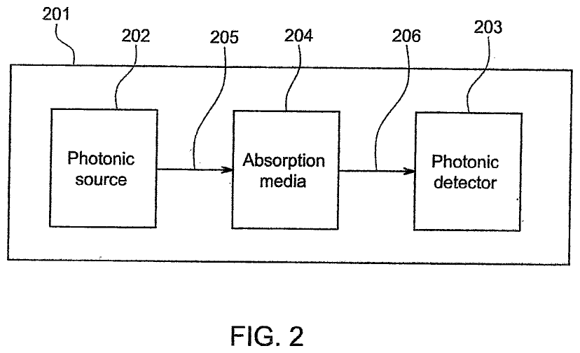

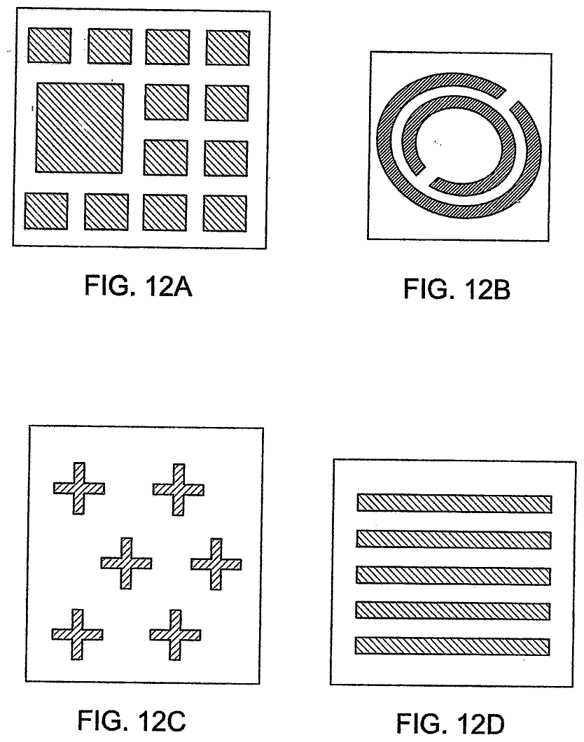

FIGS. 11A and 11B depict a synchronous switch that is sequenced by the signal analyzer and controller. The synchronous switch configuration of FIG. 11A separates a first photonic beam signal affected by intensity of the photonic beam from a signal affected by spontaneous cooling of the micro-platform. This is accomplished with sampling a transient pixel signal V_{P1} at two different times t₁ and t₃ defined in FIG. 2B. The transient signal is characterized by a time constant τₚ determined by the thermal time response of the micro-platform and its supporting nanowires.

The signal analyzer and control circuit obtains a first digital signal obtained from the ADC 1107 by selecting pixel 1101, buffering the detector signal through op amp 1103, and connected into op amp 1106 through DPDT switch 1104. This first digital signal from ADC is determined during sampling at time t₁. This first signal 1105 is the signal sum resulting from a spontaneously cooled micro-platform 1101 and heated by the photonic beam within the spectrophotometer.

The signal analyzer and control circuit obtains a second digital buffered through the same path through the DPST switch 1104 into ADC 1107. This second signal sampled at time t₃ is obtained without any signal component from the photonic beam within the spectrophotometer. At time t₂, the signal from the selected pixel is reduced as the micro-platform is heated by the internal photonic beam. The difference in signal levels monitored at t₁ and t₃ is a measure of the intensity of photonic signal received into the pixel detector.

The synchronous switching circuit is useful with a resistive bolometer wherein the photonic beam sensitivity is repetitively enabling/disabling the interrogation current through the thermistor of the bolometer. The synchronous switching circuit is useful with a pyroelectric sensor or a photodiode wherein the photon beam is repetitively chopped.

### Photonic Source and Photonic Detector Configurations

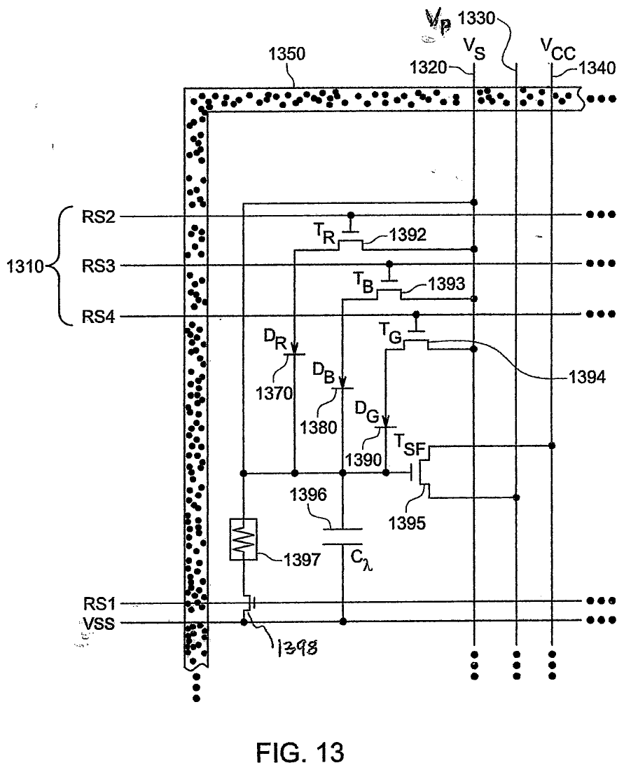

FIGS. 12A-12D depicts thin film resonant metamaterial structures disposed in plurality on a micro-platform. When these structures are created on the micro-platform of an LEP, the spectral bandwidth of photonic radiation is reduced. When these structures are created on the micro-platform of the photonic detector, the spectral bandwidth for detected radiation is reduced. In the embodiment of FIG. 12A there are two separate spectral wavelength bands corresponding to the two different area plasmonic resonators. This dual application is explained by the Kirchhoff law of thermal radiation.

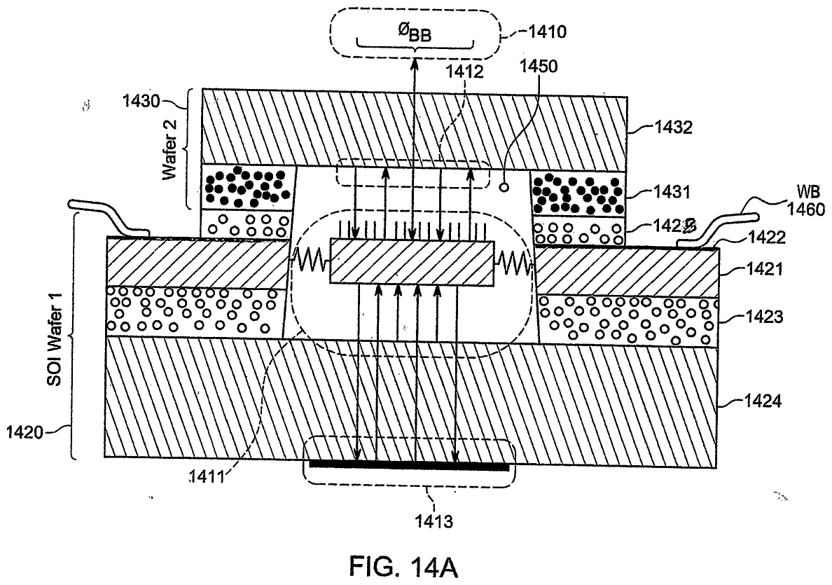

FIG. 13 depicts a detector pixel circuit providing hyperspectral detectivity. The signal analyzer and controller sequences the pixel through seven separate time intervals providing a monitoring or identification of a component within the fluid of interest. This embodiment comprises three RGB photodiodes providing visible VIS sensitivity, and a thermal platform 1397 providing MWIR sensitivity. The RGB photodiodes are disposed directly in or on the surrounding semiconductor substrate. Power supply line VCC 1340 is generally enabled at all times during pixel readout time sequencing.

All transistors are MOS enhancement-mode type except transistor TSF 1395 which is operated in a saturation-mode to permit processing of the thermal signal level which is much lower amplitude compared with the RGB diode signal levels. Thermal platform 1397 is formed with phononic MEMS nanowire structure.

During time interval 1 the three RGB diodes red D_{R} 1370, blue D_{B} 1380 and green D_{G} 1390 are biased negatively. This is accomplished with VS 1320 set to a negative value with lines RS1, RS2, RS3, RS4 set high, enabling transistors T_{R} 1392, T_{B} 1393 T_{B} 1394.

During time interval 2 the three RBG diodes are open circuited by RS1, RS2, RS3, RS4 set low permitting the RBG diodes to float electrically. During this interval the diodes are exposed to the photonic beam from the fluid of interest and the diode voltage is lowered by charge recombination in each diode.

Next, the voltage on the photodiodes RGB are readout during separate time intervals 3, 4, 5. Levels RS2, RS3, RS4 are enabled during separate time intervals. RS1 is set to zero disabling transistor 1398. Readout is accomplished by readout of voltage from capacitor C_{A} through analog source follower TSF 1395 into pixel signal line VP 1330.

In FIG. 13, signal readout of temperature of the thermal platform 1397 is obtained during time intervals 6 and 7 wherein voltage is sampled at respective times t₁ and t_{d}, based on the with the configuration method disclosed with FIG. 11A. Signal readout is provided into line VP 1330 through source follower transistor TSF 1395.

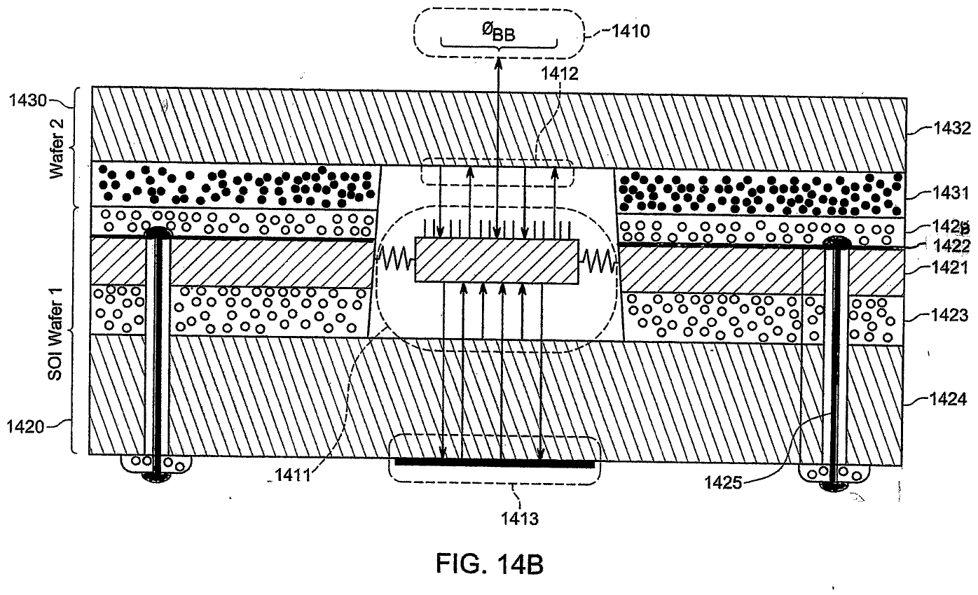

FIG. 14A is a cross-sectional view depicting a phononic MEMS pixel configured with a micro-platform with a nanotube absorber 1411 disposed within hermetic cavity 1450. The pixel is illustrated with a wire bonded WB connection 1460 to metallization 1422. The pixel in this embodiment can be operated either as a photonic source or a photonic detector. The platform can be operated as an LEP providing radiation ϕ_{BB} when the micro-platform is heated to a higher temperature, or operated as a detector when the photonic beam is absorbed into the platform.

In FIG. 14A a reflecting mirror 1413 provides a useful increase in photometric response for the micro-platform. Reflected light and black body radiation from cavity wall 1412 is indicated as 1412. FIG. 14B is a cross-sectional view depicting a micro-platform with a nanotube absorber and with a through-silicon-via (TSV) interpixel connection. The pixel is fabricated from a starting semiconductor wafer wherein the micro-platform and nanowires are created. A final step in the fabrication process is to bond wafer2 to wafer1 creating the hermetic cavity. In a preferred embodiment, the wafers are silicon and both substrates comprise float zone silicon.

In FIG. 14A the micro-platform and nanowires 1413 are formed from layer 1421 within wafer 1420. Layers 1424, 1421, 1423, and substrate comprise semiconductor, dielectric, and semiconductor, respectively. In this example embodiment, wafer2 1430 with substrate 1432 is bonded to the processed wafer1 with metal seal 1431 and electrically isolated with dielectric layer 1424.

FIG. 14B is a cross-sectional view similar to the dual purpose pixel of FIG. 14A except that through-semiconductor-vias (TSV) connections 1425 from the pixel (or a pixel array) are provided instead of the wire bonds WB 1460.

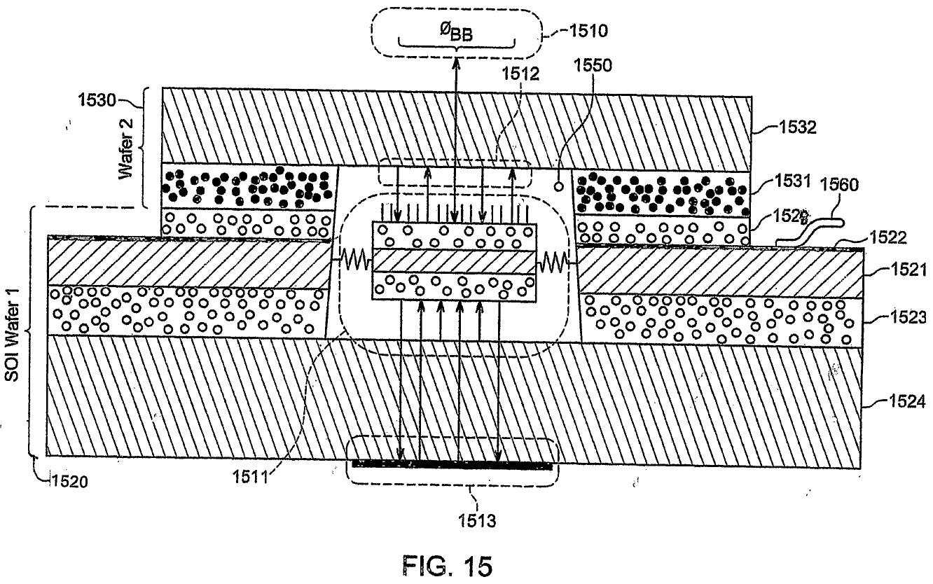

FIG. 15 is a cross-sectional depiction of a silicon pixel wherein the micro-platform and nanowires 1511 are formed with a grown oxide film on both sides of the micro-platform. This film is SiO2 which provides more mechanical strength than silicon. The thermal conductivity of the silicon nanowire is reduced increasing thermal isolation for the micro-platform.

The structure of the FIG. 15 example is similar to that of FIG. 14A wherein connection to an individual pixel or an array of pixels is obtained with a wire bond 1560 to internal connecting metal film 1522.

The starting micro-platform and supporting nanowires 1511 are fabricated from wafer1. Wafer1 comprises dielectric isolation 1524, active silicon layer 1521, BoX layer 1523, and substrate 1524. Wafer2 is bonded to processed wafer1 with metallic seal 1531. The micro-platform and nanowires are suspended within hermetic cavity 1550.

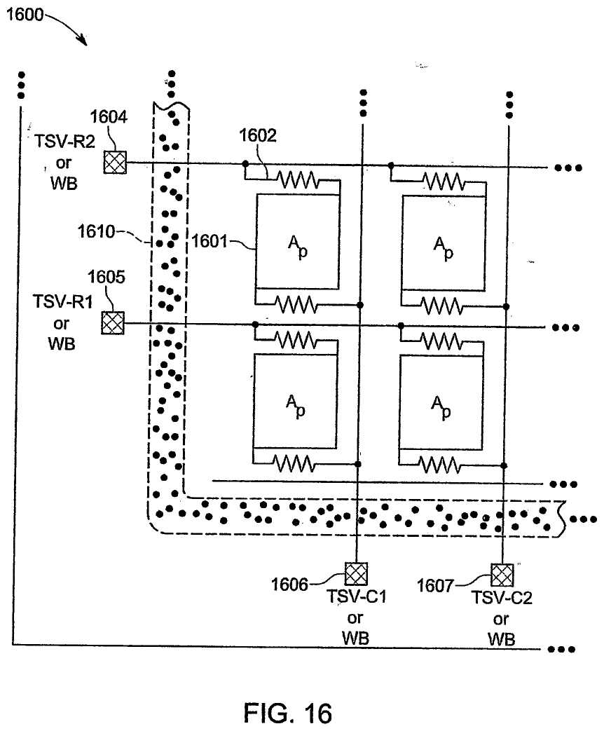

FIG. 16 is a plan view depicting an array of four interconnected phononic MEMS pixels 1601 with TSV connections 1604-1607 onto the surrounding substrate. The hermetic seal 1610 surrounds the array. These pixels may comprise the photonic source or the photonic detector with phononic MEMS nanowires 1602. In this example individual pixels may be addressed through the TSV connection around the periphery of the pixel array. In other arrayed applications, the pixels may be interconnected with the pixels connected into a series/parallel combination circuit.

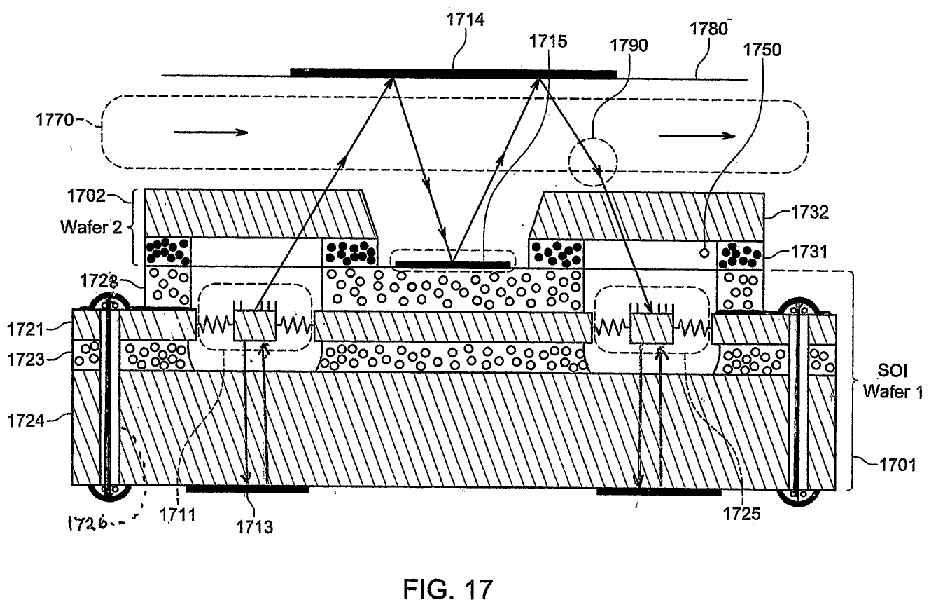

FIG. 17 is a cross-sectional view depicting the spectrophotometer with the photonic source 1711 and the photonic detector 1725 comprising phononic MEMS structure and sharing a common substrate formed from wafer1 1701. The fluid of interest 1770 is disposed between mirrors 1714 on external surface 1780 and mirror 1715 disposed on wafer1. The photonic source and photonic detector are connected to through-semiconductor-vias within wafer1. Mirrors 1713 disposed on substrate 1724 reflect light back into the micro-platform increasing power efficiency and sensitivity for the photonic source 1711 and detector 1725, respectively.

Starting wafer1 1701 with added dielectric film 1728 comprises, active semiconductor layer 1721 and dielectric layer 1723 over surrounding substrate 1724. Processed wafer1 is bonded to wafer2 1702 following the platform and nanowire release step, wherein a bonding material 1731 forms the hermetic cavity 1750.

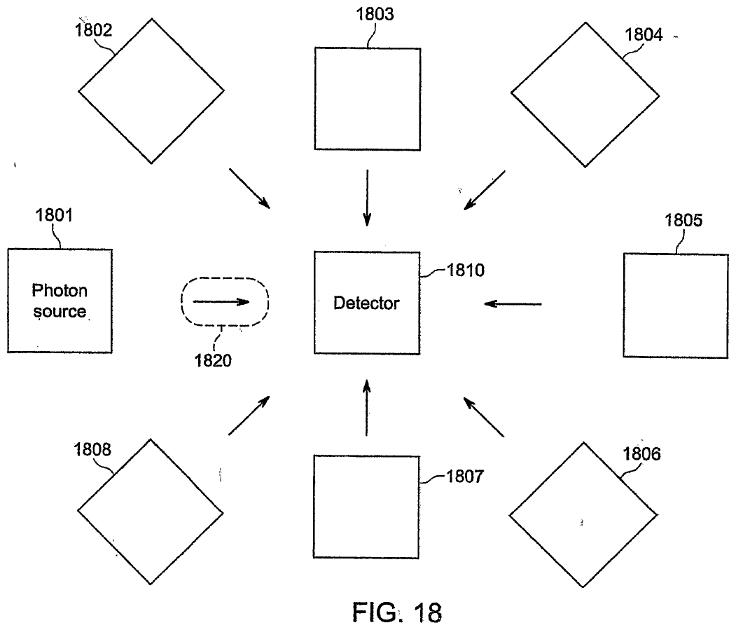

FIG. 18 is a plan view depicting the spectrophotometer comprising eight photon sources 1801-1808 and with photonic beams 1820 directed into a single detector 1810. In this embodiment, the micro-platform of each photonic source is configured with a resonant plasmonic filter providing radiation at a unique wavelength of interest.

The detector is sensitive over a broadband of wavelengths that includes the spectrum of radiation from all photonic sources 1801-1808. Generally, the photonic source and photonic detector are disposed on an extended flat surface.

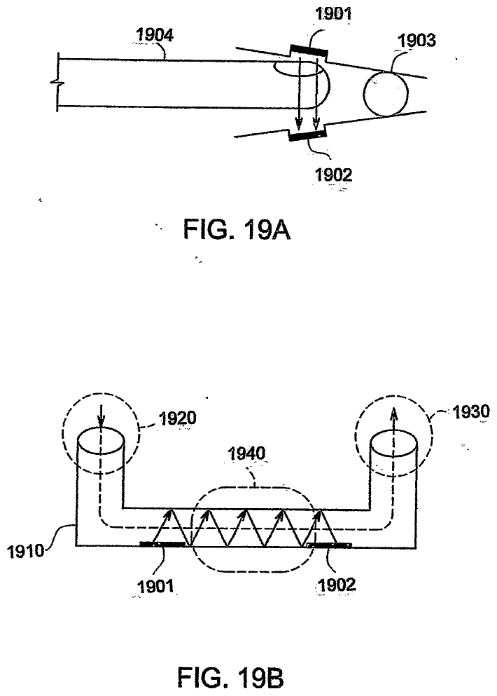

FIG. 19A is a cross-sectional view depicting the spectrophotometer comprising a photonic source 1901 and a photonic detector 1902 with the photonic beam guided through blood in a human finger 1904. The photon source and photon detector are clamped onto an inserted finger with mechanical spring 1903. This embodiment comprises a photonic source and a photonic detector on separate substrates.

FIG. 19B is a cross-sectional view depicting the spectrophotometer comprising a photonic source 1901 and a photonic detector 1902 wherein the fluid of interest 1940 is human exhaled breath. The human subject breathes into orifice 1920 with open orifice 1930. This embodiment the photonic source and photonic detector may share the same substrate.

### Characterization of the Source and Detector

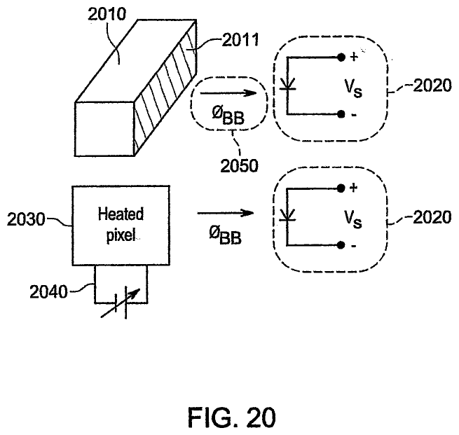

FIG. 20 depicts components for characterizing the photonic source power efficiency and the photonic detector NEP.

A calibrated blackbody source 2010 operated near room temperature provides photonic beam ϕ_{BB} 2050 to photonic detector 2020. The detector with linear response is calibrated by extrapolating the detector signal level over the detector dynamic range to NEP power level.

Power efficiency of the photonic source 2030 powered from supply 2040 supplies a photonic beam ϕ_{BB} into calibrated photonic detector 2020. In some cases, the photonic detector 2020 is independently calibrated.

### Detectivity Enhancement for a Silicon Photonic Detector Micro-Platform

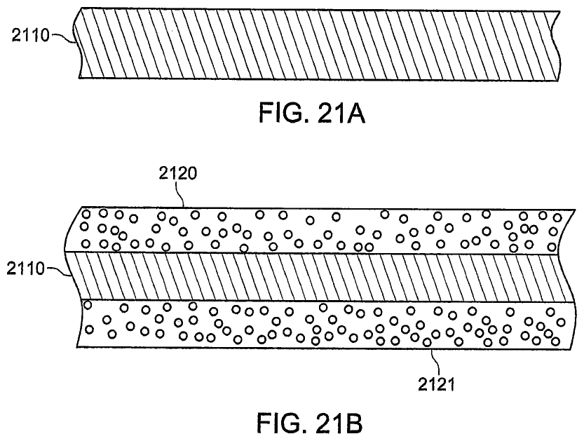

FIGS. 21A, 21B are cross-sectional views depicting a silicon nanowire before 2110 and after 2120 growing an oxide layer in a heated oxygen atmosphere.

The oxide grown on the supporting nanowires can significantly increase the mechanical shock resistance and also further reduce the thermal conductivity of the nanowires within a pixel. This oxidation step is performed prior to wafer bonding after the release step for platform and nanowires. In this embodiment, a high temperature metallization is used to withstand the oxidation temperature.

### Phononic MEMS Spectrophotometer Applications

In embodiments, the fluid of interest comprises one or more of, without limitation, an atmosphere comprising an exhaust or smokestack effluent, drinking water, breath, blood, urine, and a liquid or gaseous product from a chemical reaction. In embodiments, multiple wavelength bands attenuated in the fluid of interest are monitored to increase the confidence level for a single component within the fluid of interest. In embodiments, one or more photonic sources can provide separate wavelengths for monitoring separate components within the fluid of interest.

Photonic beams and detection with limited bandwidth range is enhanced with metamaterial plasmonic filters disposed in the micro-platform of either of both the photonic source and detector.

In embodiments, wherein the spectrophotometer is implanted inside a living body, tissue components may be monitored or identified.

In embodiments, the fluid of interest comprises one or more or more of, without limitation, chemical species O2, H2, H2O, H2O2, CH4, BBr3, C2H6, C2H2, HBr, CO, CO2, NH3, NO, NO2, C2H5OH ethanol, and CH2O.

In embodiments, such as gas monitors for exhaust fumes or smokestack effluent, the fluid of interest comprises reflective particulates such as dust and sand. The spectrometer can be calibrated for sensing reflective particulates to provide applications such as a smoke alarm.

In embodiments, the spectrophotometer is configured for operation as an oximeter sensitive to the hemoglobin oxygen content of blood. The example configuration of FIG. 19A can be used for a pulsed oximeter. In a common embodiment, the spectrometer monitors multiple wavelengths which include a first reference wavelength and second wavelength specifically absorbed by blood oxygen.

In embodiments, the spectrophotometer is configured to monitor the glucose content of blood. This embodiment may monitor a first reference wavelength, in addition to separate multiple wavelength bands wherein glucose in blood specifically attenuates the photonic beam to the detector.

In many applications, usefulness and cost effectiveness is enhanced by powering a compact embodiment of the spectrophotometer with a miniature battery. The photonic source and detector configurations disclosed in this invention support compact spectrophotometer implementations.

While the invention has been described in detail by specific reference to preferred embodiments, it is understood that variations and modifications may be made without departing from the true spirit and scope of the invention. It is to be understood that although the disclosure teaches many examples of embodiments in accordance with the present teachings, any additional variations of the invention can easily be devised by those skilled in the art after reading this disclosure. As a consequence, the scope of the present invention is to be determined by the following claims.

What is claimed is:

1. A phononic MEMS spectrophotometer (PMS) comprising a photonic source and a photonic detector wherein a photonic beam from the photonic source is directed through a fluid of interest into photonic detector, and further wherein:
the photonic source comprises one or more of a semiconductor LEP, a semiconductor LED, and/or a laser providing the photonic beam with spectral components within VIS-LWIR wavelength range;
the photonic detector comprises one or more of a thermoelectric thermopile, resistive bolometer, pyroelectric sensor or photodiode;
the semiconductor LEP photonic source and the photonic detector each comprise one or more of a micro-platform suspended with phononic MEMS nanowires from an isothermal surrounding substrate;
the micro-platform is configured to provide increased absorptive sensitivity for radiation spectral components within the photonic beam;
the phononic MEMS nanowires comprise one or more area-sections comprising discrete phononic structure, each area section comprising one or more layers of phononic crystal or randomly disposed phononic scattering elements, thereby providing a decreased thermal conductivity along the length of the nanowires;
the distance between elements within the discrete phononic structure within the nanowire area-section is less than the mean free path (mfp) of at least some heat conducting phonons;
the phononic MEMS nanowires comprise one or more layers of semiconductor, dielectric, or metallic film, providing one or more of, without limitation, an increase in mechanical strength, an increase in electrical conductivity, static positioning, or electrical isolation;
the phononic MEMS nanowires increase the ratio of electrical to thermal conductivity within each nanowire;
the micro-platform and nanowires are disposed within a hermetic cavity; and,
the signal levels from the detector are processed with a signal analyzer to provide a monitoring or identification of one or more components within the fluid of interest.

2. The PMS of claim 1 comprising one or more micro-platforms, each micro-platform suspended by phononic MEMS nanowires from the isothermal surrounding substrate.

3. The PMS of claim 2 wherein a plurality of the micro-platforms comprise photonic sources connected in a series/parallel circuit providing a load impedance matched to a selected source of electrical power or multiple wavelengths of radiation.

4. The PMS of claim 1 wherein the photonic detector comprises a plurality of micro-platforms providing an increased output signal level, multiple wavelength bands of spectral sensitivity, or multiple thermal time constants.

5. The PMS of claim 1 wherein at least one detector micro-platform is sufficiently thermally isolated with phononic MEMS nanowires, and said micro-platform cools itself by its own blackbody radiation.

6. The PMS of claim 5 wherein a synchronous detection configuration separates the signal resulting from spontaneous cooling of the micro-platform from the signal affected by the fluid of interest.

7. The PMS of claim 1 wherein a mirror exposed to one surface of the micro-platform reflects light to the micro-platform, thereby increasing radiation source efficiency η or detector responsivity R of said micro-platform.

8. The PMS of claim 1 wherein a micro-platform comprises resonant structure controlling the wavelength bandwidth of emissivity or absorptivity according to the Kirchhoff law of photonic radiation.

9. The PMS of claim 1 wherein a micro-platform comprises, without limitation, carbon nanotubes, graphene, silicon black, carbon black, and gold black, providing an increase in emissivity or absorptivity for the photonic source or photonic detector, respectively, according to the Kirchhoff law of photonic radiation.

10. The PMS of claim 1 wherein the phononic MEMS nanowires comprise one or more layers of crystalline or polycrystalline semiconductor material selected from the group comprise, without limitation, silicon, silicon germanium, germanium, silicon carbide, gallium nitride, vanadium oxide, and complex thermoelectric semiconductor.

11. The PMS of claim 10 wherein the nanowires are comprised of silicon and oxidized in a heated oxygen-rich environment after release to create the dielectric film on both sides of the nanowire, thereby increasing nanowire mechanical strength and decreasing thermal conductivity.

12. The PMS of claim 1 wherein one or more layers of a dielectric within the nanowires is selected from the group, without limitation, silicon dioxide, aluminum oxide, and silicon nitride.

13. The PMS of claim 1 wherein the discrete structural elements within the phononic MEMS nanowire comprise, without limitation, holes, vias, pillars, surface dots, plugs, cavities, indentations, surface particulates, roughened edges, implanted molecular species, porous structure, and molecular aggregates, disposed in a periodic or random format.

14. The PMS of claim 1 wherein the fluid of interest comprises one or more of, without limitation, an atmosphere comprising an exhaust or smokestack effluent, drinking water, breath, blood, urine, and a liquid or gaseous product from a chemical reaction.

15. The PMS of claim 14 wherein the fluid of interest comprises one or more or more of, without limitation, O2, H2O, H2O2, CH4, BBr3, C2H6, C2H2, HBr, CO, CO2, NH3, NO, NO2, C2H5OH ethanol, and CH2O.

16. The PMS of claim 14 wherein the fluid of interest comprises reflective particulates such as dust and sand.

17. The PMS of claim 14 configured for operation as an oximeter sensitive to the hemoglobin oxygen content of blood.

18. The PMS of claim 14 configured to monitor the glucose content of blood.

19. The PMS of claim 14 wherein the fluid of interest comprises, without limitation, biomedical tissue or material from within a living body.

20. The PMS of claim 1 wherein the micro-platform is formed with a width dimension within the range 1 to 2000 micrometers and the phononic nanowires are formed with a thickness within the range 10 to 500 nanometers.
